(19) United States
(12) Patent Application Publication
(10) Pub. No.: US 2009/0259758 A1
(43) Pub. Date: Oct. 15, 2009

(54) METHOD AND SYSTEM FOR SESSION MIGRATION

(76) Inventors: Jian CHEN, Shenzhen (CN); Hao WANG, Shenzhen (CN); Hongguang GUAN, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/487,727

(22) Filed: Jun. 19, 2009

Related U.S. Application Data
(63) Continuation of application No. PCT/CN2008/070016, filed on Jan. 3, 2008.

(30) Foreign Application Priority Data
May 28, 2007 (CN) 200710105262.4

(51) Int. Cl. G06F 15/16

(52) U.S. Cl. 709/228

(57) ABSTRACT

A method for session migration includes: sending a request for transferring a session from a source terminal to a target terminal; receiving, by a media transfer controller, the request; and transferring, by the media transfer controller, the session to the target terminal by negotiating with the media relay. A system for session migration is also provided. Through the present disclosure, speed and efficiency for a session migration service are improved.

### CROSS-REFERENCE TO RELATED APPLICATIONS

This application is a continuation of International Patent Application No. PCT/CN2008/070016, filed on Jan. 3, 2008, which claims priority to Chinese Patent Application No. 200710105262.4, filed with the Chinese Patent Office on May 28, 2007, both of which are incorporated herein by reference in their entirety.

### FIELD OF THE INVENTION

The present disclosure relates to the communication field, and in particular, to a method and system for session migration.

### BACKGROUND

Suppose that Alice is watching a new movie on the television in her lounge but she needs to prepare dinner in the kitchen at six o'clock in the evening. Alice does not want to miss the movie, so she continues to watch the movie through a display device in the kitchen while preparing dinner.

FIG. 1 shows a call forwarding service in the prior art. As shown in FIG. 1, a user A has two terminals A1 and A2, and a user B has a terminal B. The terminal A1 has a session with the terminal B and a media stream between them is forwarded through a media relay. The user A wants to transfer the session from the terminal A1 to the terminal A2.

Based on the prior art, the process is:

the session and the media stream between the terminal A1 and terminal B are disconnected;

a session is created between the terminal A2 and terminal B through signaling; and

a media stream is created between the terminal A2 and terminal B.

In the foregoing example, the media stream needs to be disconnected first, and then a new media stream is created by setting up a new end-to-end signal.

### SUMMARY

A method and system for session migration are provided in various embodiments of the present disclosure which improves the speed and efficiency of a session migration service.

A method for session migration provided in the present disclosure includes:

sending a request for transferring a session from a source terminal to a target terminal;

receiving, by a media transfer controller, the request; and

transferring the session to the target terminal according to the request by negotiating with a media relay.

A system for session migration provided in the present disclosure includes:

a source terminal and a target terminal connected to a media transfer controller;

a media relay configured to connect the target terminal with the media transfer controller;

a media transfer controller configured to receive the request for transferring a session from the source terminal to the target terminal and transfer the session to the target terminal according to the request by negotiating with the media relay.

Through the foregoing method, a session can be transferred prior to disconnecting a media stream.

### BRIEF DESCRIPTION OF THE DRAWINGS

FIG. 1 shows a call forwarding service in the prior art;

FIG. 2 shows a communication system for session migration in an embodiment of the present disclosure;

FIG. 3 is a flowchart of a session migration method provided in an embodiment of the present disclosure;

FIG. 4 is a signaling flowchart of a session migration method provided in an embodiment of the present disclosure in the first scenario;

FIG. 5 is a signaling flowchart of a session migration method provided in an embodiment of the present disclosure in the second scenario;

FIG. 6 is a signaling flowchart of a session migration method provided in an embodiment of the present disclosure in the third scenario;

FIG. 7 is a signaling flowchart of a session migration method provided in an embodiment of the present disclosure in the fourth scenario; and

FIG. 8 is a signaling flowchart of a session migration method provided in an embodiment of the present disclosure in the fifth scenario.

### DETAILED DESCRIPTION

The technical solution under the present disclosure is detailed below by reference to accompanying drawings and preferred embodiments.

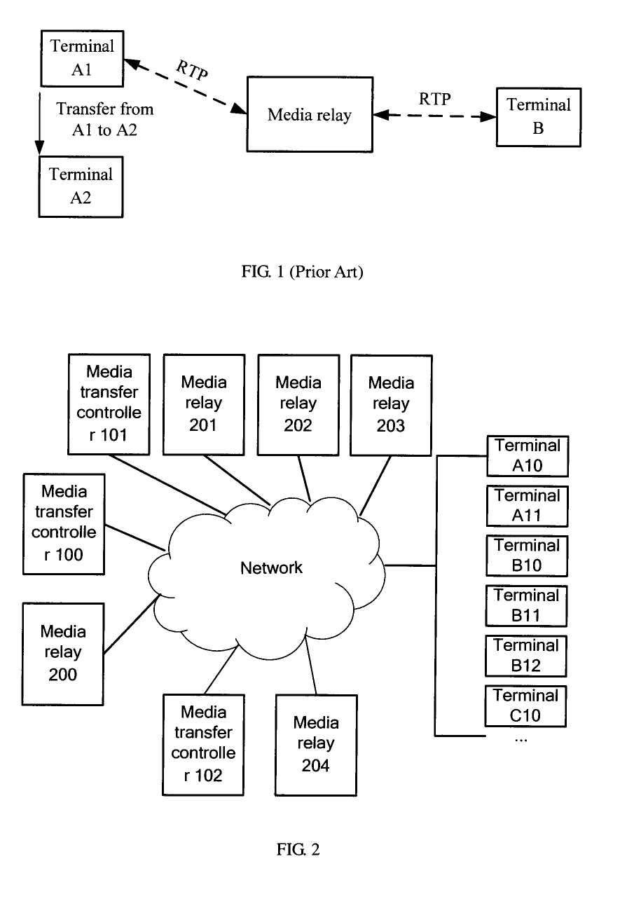

FIG. 2 shows a communication system for session migration in an embodiment of the present disclosure. The communication system includes:

a media transfer controller adapted to receive a media switching request from a terminal and interact with a media relay to implement media switching and deployed in the terminal, session controller or media relay, or deployed separately, where one media transfer controller may control one or more media relays;

a media relay, adapted to forward media; and

a terminal attributable to a media controller and a media relay.

As shown in FIG. 2, a media transfer controller 100 controls a media relay 200; a media transfer controller 101 controls a media relay 201, a media relay 202, and a media relay 203; and a media transfer controller 102 controls a media relay 204. A terminal A10 and a terminal A11 are attributable to the media transfer controller 100 and the media relay 200. A terminal B10 is attributable to the media transfer controller 101 and the media relay 201. A terminal B11 is attributable to the media transfer controller 101 and the media relay 202. A terminal B12 is attributable to the media transfer controller 101 and the media relay 203. A terminal B10 is attributable to the media transfer controller 102 and the media relay 204.

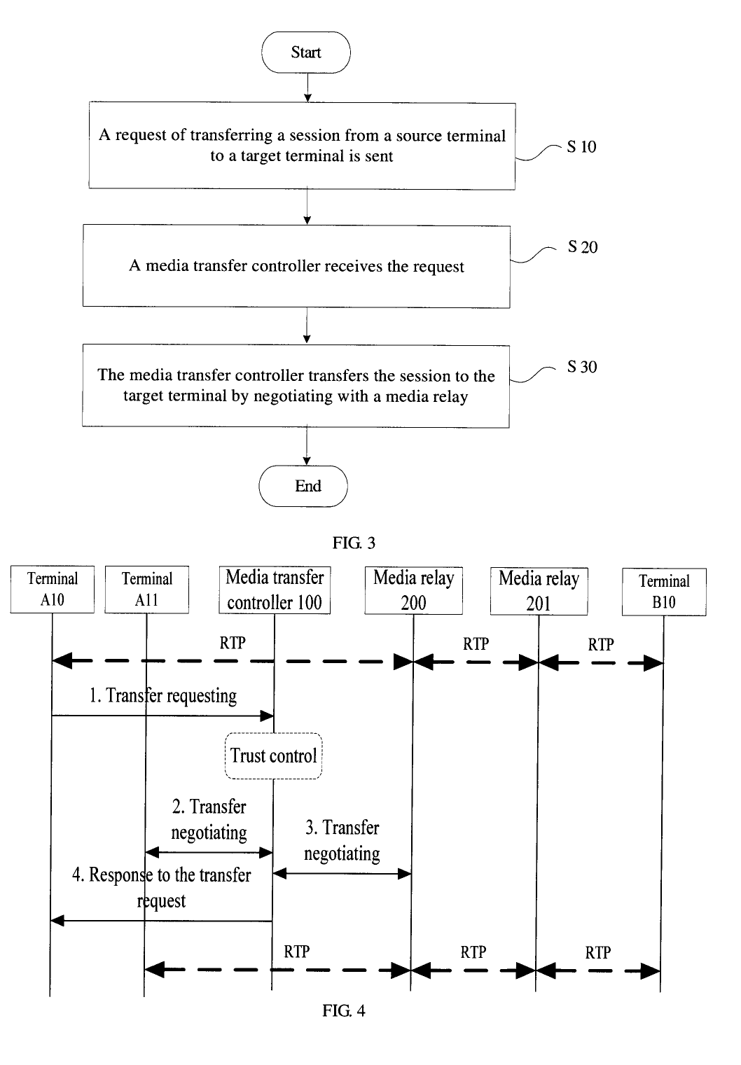

FIG. 3 is a flowchart of a session migration method provided in an embodiment of the present disclosure. The flowchart includes the following steps:

Step S10: A request for transferring a session from a source terminal to a target terminal is sent.

Step S20: The media transfer controller receives the request.

Step S30: The media transfer controller transfers the session to the target terminal by negotiating with the media relay.

It is not necessary to disconnect the media stream before transferring the session, improving the speed and efficiency of session migration.

Exemplary applications of the foregoing method is detailed below through the scenarios illustrated FIG. 4-FIG. 8.

FIG. 4 shows scenario 1: The source terminal triggers migration proactively.

As shown in FIG. 4, the terminals A10 and A11 are attributable to the media transfer controller 100 and the media relay 200, and the terminal B10 is attributable to the media relay 201 (this media relay is not controlled by the media transfer controller 100). The terminal A10 is in a conversation with the terminal B10. Through the terminal A10, the user requests to transfer the conversation to the terminal A11. Existing protocols, including but not limited to, Session Initiation Protocol (SIP), Media Gateway Control Protocol (MGCP), H.323, and H.248 may be applied or extended to implement the foregoing embodiment. The exemplary embodiment described here uses SIP. The steps are as follows:

1. The terminal A10 requests the media transfer controller 100 to transfer the session to the terminal A11, and the media transfer controller 100 judges whether the session can be transferred from the terminal A10 to the terminal A11. For example, the terminal A10 sends a REFER message to the media controller 100, requesting to transfer the session. The message may include: session ID of the session between the terminal A10 and the terminal B10, ID of the target terminal A11, and validity period of session migration.

2. The media transfer controller 100 negotiates with the terminal A11 about transfer parameters. For example, the media controller 100 sends an INVITE message to the terminal A11. The INVITE message may carry the session description information used by the media relay 200 in transferring the current session. For example, the message may be encapsulated through the Session Description Protocol (SDP). The session description information may include: IP address, port number, coding format, and decoding format. After receiving the INVITE message, the terminal A11 may respond with a 200 OK message, which carries the session description information of the terminal A11. The message may be encapsulated using SDP. The session description information may include: IP address, port number, coding format, and decoding format. After receiving the 200 OK message, the media controller 100 sends an acknowledgement (ACK) message to terminal A11.

3. The media transfer controller 100 negotiates with the media relay 200 about transfer parameters. For example, the media controller 100 may send an INVITE message to the terminal media relay 200. The INVITE message may carry the session description information used by terminal A11 in attempting to join the current session, for example, the message may be encapsulated through the SDP. The session description information may include: IP address, port number, coding format, and decoding format. After receiving the INVITE message, the terminal media relay 200 may respond with a 200 OK message, which may carry the session description information of the terminal media relay 200. For example, the message may be encapsulated using SDP. The session description information includes: IP address, port number, coding format, and decoding format. After receiving the 200 OK message, the media controller 100 may send an ACK message to the terminal media relay 200.

4. The media transfer controller responds to the transfer request of the terminal A10. For example, the media controller 100 sends a 200 OK message to the terminal A10 in response to the REFER message.

Through the messages sent in the foregoing step 2 and step 3, the signaling is set up between the terminal A11 and the media relay 200, and session information (such as IP address, port number, coding format, and decoding format) is negotiated between the terminal A111 and the media relay 100 through the session description information carried in such messages. According to the negotiation result, the terminal A11 and the media relay 100 can transfer the session. In one embodiment, the terminal A11 and the media relay 100 may transmit the media stream using a real-time transmission protocol (RTP).

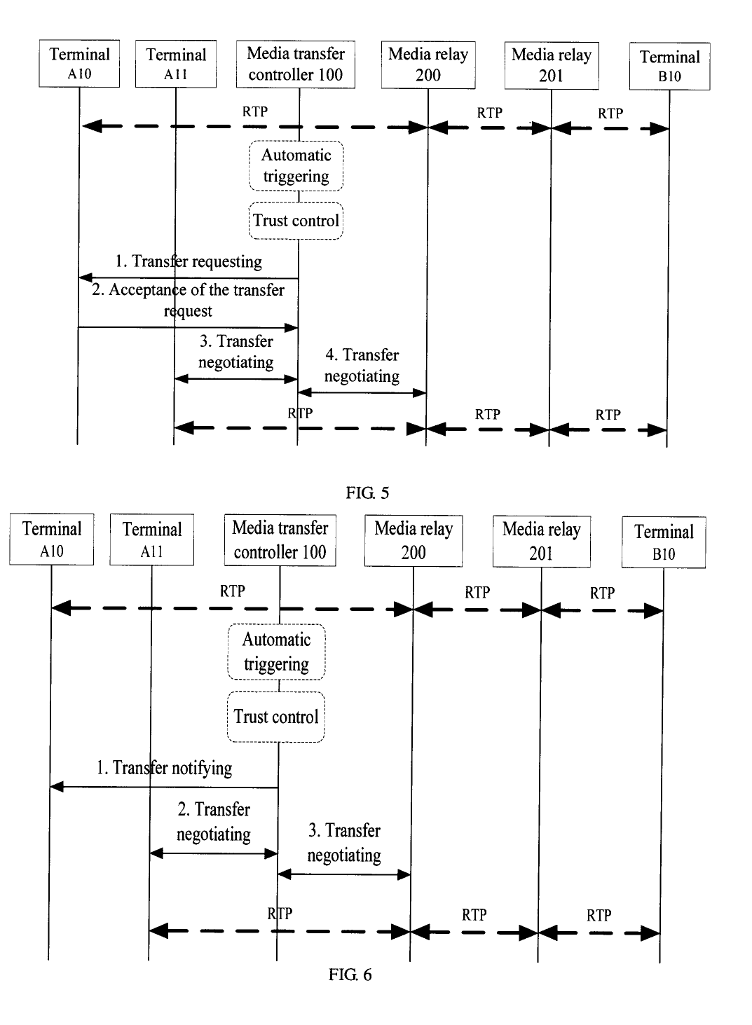

FIG. 5 shows scenario 2: The media transfer controller triggers migration and the source terminal is controllable.

As shown in FIG. 5, the terminals A10 and A11 are attributable to the media transfer controller 100 and the media relay 200, and the terminal B10 is attributable to the media relay 201, which is not controlled by the media transfer controller 100. The terminal A10 is in a conversation with the terminal B10 and the media transfer controller 100 triggers the transfer according to the environment perception system and the configuration system. For example, the terminal A10 may be configured to transfer the session to the terminal A11 under certain time and place conditions, and the time and place parameters may be obtained through the environment perception system. Alternatively, the terminal A10 may confirm whether to transfer the session. The steps are as follows:

1. The media transfer controller 100 automatically triggers a transfer request. At this time, the media transfer controller 100 may judge whether the session can be transferred from the terminal A10 to the terminal A11 according to an established trust system. If the session can be transferred, the media transfer controller 100 may send a transfer confirmation request to the terminal A10.

2. The terminal A10 responds with a consent.

3. The media transfer controller 100 negotiates transfer parameters with the terminal A11.

4. The media transfer controller 100 negotiates transfer parameters with the media relay 200 and then transfers the session to the target terminal through the RTP according to the negotiated transfer parameters.

FIG. 6 shows scenario 3: The media transfer controller triggers migration and the source terminal is uncontrollable.

As shown in FIG. 6, the terminals A10 and A11 are attributable to the media transfer controller 100 and the media relay 200, and the terminal B10 is attributable to the media relay 201, which is not controlled by the media transfer controller 100. The terminal A10 is in a conversation with terminal B10. The media transfer controller 100 triggers the transfer according to the environment perception system and the configuration system. For example, the terminal A10 may be configured to transfer the session to the terminal A11 under certain time and place conditions. The time and place parameters may be obtained through the environment perception system. In the exemplary embodiment, the terminal may not need to confirm whether to transfer the session, but the terminal is notified of the transfer. The steps are as follows:

1. The media transfer controller 100 automatically triggers a transfer request. At this time, the media transfer controller 100 may judge whether the session can be transferred from the terminal A10 to the terminal A11 according to an established trust system. If the session can be transferred, the media transfer controller notifies the terminal A10 that session transfer is required.

2. The media transfer controller 100 negotiates transfer parameters with the terminal A11.

3. The media transfer controller 100 negotiates transfer parameters with the media relay 200 and then transfers the session to the target terminal through the RTP according to the negotiated transfer parameters.

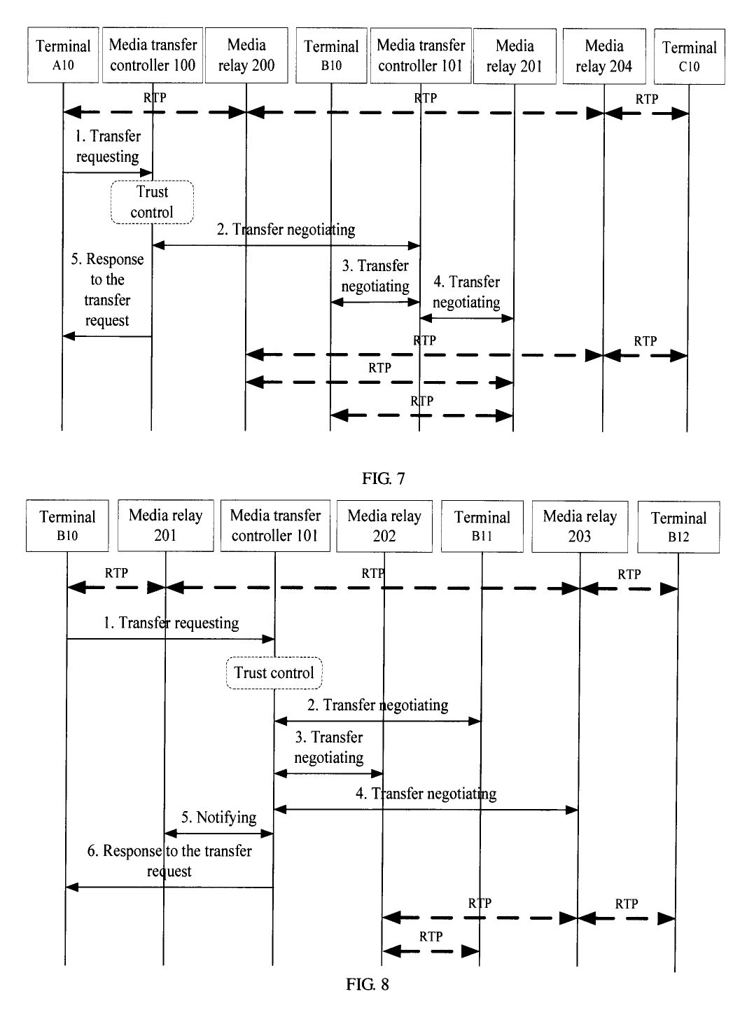

FIG. 7 shows scenario 4: The source terminal and the target terminal are attributable to different media transfer controllers.

As shown in FIG. 7, the terminal A10 is attributable to the media transfer controller 100 and the media relay 200, the terminal B10 is attributable to the media transfer controller 101 and the media relay 201, and the terminal C10 is attributable to the media relay 204, which is not controlled by the media transfer controller 100 or the media transfer controller 101. The terminal A10 is in a conversation with the terminal C10. Through the terminal A10, the user requests to transfer the conversation to the terminal B10. The steps are as follows:

1. The terminal A10 requests the media transfer controller 100 to transfer the session. At this time, the media transfer controller 100 may judge whether the session can be transferred from the terminal A10 to the terminal B10 according to an established trust system.

2. The media transfer controller 100 negotiates transfer parameters with the media transfer controller 101.

3. The media transfer controller 101 negotiates transfer parameters with the terminal B10.

4. The media transfer controller 101 negotiates transfer parameters with the media relay 201.

5. The media transfer controller 100 responds to the transfer request of the terminal A10 and then transfers the session to the target terminal through the RTP according to the negotiated transfer parameters.

FIG. 8 shows scenario 5: One media transfer controller controls multiple media relays. As shown in FIG. 8, the terminal B10, the terminal B11 and the terminal B12 are attributable to the media transfer controller 101. The terminal B10 is attributable to the media relay 201, the terminal B11 is attributable to the media relay 202, and the terminal B12 is attributable to the media relay 203. The media relay 201, the media relay 202, and the media relay 203 are controlled by the media transfer controller 101. The terminal B10 is in a conversation with the terminal B12. Through the terminal B10, the user requests to transfer the conversation to the terminal B11. The steps are as follows:

1. The terminal B10 requests the media transfer controller 101 to transfer the session. At this time, the media transfer controller 101 may judge whether the session can be transferred from the terminal B10 to the terminal B11 according to an established trust system.

2. The media transfer controller 101 negotiates transfer parameters with the terminal B11.

3. The media transfer controller 101 negotiates transfer parameters with the media relay 202.

4. The media transfer controller 101 negotiates transfer parameters with the media relay 203.

5. The media transfer controller 101 notifies the media relay 201.

6. The media transfer controller 101 responds to the transfer request of the terminal B10 and then transfers the session to the target terminal through the RTP according to the negotiated transfer parameters.

Thus, the session migration method under the present disclosure may implement the session migration service without participation of the communication peer and without setting up any end-to-end signaling, thereby accomplishing higher speed and efficiency.

Preferably, buffering may be performed on the media relay to make the transfer smoother.

Preferably, the media relay may send media streams to the source terminal (a terminal A1) and the target terminal (a terminal A2) concurrently in a specific period to improve the user experience.

Preferably, a media codec adapter may be deployed between the media relays or on the media relays.

Based on the foregoing method, a system for session migration is provided in an embodiment of the present disclosure. The system includes: a source terminal and a target terminal connected to a media transfer controller; a media transfer controller configured to receive the request for transferring a session from the source terminal to the target terminal and transfer the session to the target terminal through negotiation with the media relay; and a media relay configured to connect the target terminal with the media transfer controller.

Through the foregoing method, it is not necessary to disconnect the media stream before transferring the session. Therefore, the speed and the efficiency of a session migration are improved.

Although the disclosure is described through some exemplary embodiments, the disclosure is not limited to such embodiments. It is apparent that those skilled in the art can make various modifications and variations without departing from the scope of the disclosure. The disclosure is intended to cover the modifications and variations that fall in the scope of protection defined by the following claims or their equivalents.

What is claimed is:

1. A method for session migration, comprising:
sending a request for transferring a session from a source terminal to a target terminal;
receiving, by a media transfer controller, the request; and
transferring the session to the target terminal according to the request by negotiating with a media relay.

2. The method of claim 1, wherein the sending of the request for transferring the session from the source terminal to the target terminal further comprises:
triggering, by the source terminal, the request for transferring the session to the target terminal proactively, and sending the request to the media transfer controller.

3. The method of claim 2, wherein the transferring the session to the target terminal according to the request by negotiating with a media relay comprises:
negotiating, by the media transfer controller, transfer parameters with the target terminal;
negotiating transfer parameters with the media relay;
responding to the request for transferring the session from the source terminal to the target terminal; and
transferring the session to the target terminal according to the negotiated transfer parameters.

4. The method of claim 1, wherein the sending of the request for transferring the session from the source terminal to the target terminal comprises:
triggering, by the media transfer controller, the request for transferring the session to the target terminal;
sending the request to the source terminal;
accepting, by the source terminal, the request; and
responding to the media transfer controller.

5. The method of claim 4, wherein the transferring the session to the target terminal according to the request by negotiating with a media relay comprises:
negotiating, by the media transfer controller, transfer parameters with the target terminal;
negotiating transfer parameters with the media relay; and
transferring the session to the target terminal according to the negotiated transfer parameters.

6. The method of claim 1, wherein the sending the request for transferring the session from the source terminal to the target terminal comprises:
triggering, by the media transfer controller, the request for transferring the session to the target terminal;
and notifying the source terminal of the request.

7. The method of claim 6, wherein the transferring the session to the target terminal according to the request by negotiating with the media relay comprises:
negotiating, by the media transfer controller, transfer parameters with the target terminal;
negotiating transfer parameters with the media relay about the transfer parameters; and
transferring the session to the target terminal according to the negotiated transfer parameters.

8. The method of claim 1, further comprising:
wherein the source terminal is attributable to a first media transfer controller and a first media relay; and
wherein the target terminal is attributable to a second media transfer controller and a second media relay.

9. The method of claim 8, wherein transferring the session to the target terminal according to the request by negotiating with the media relay comprises:
negotiating, by the first media transfer controller, transfer parameters with the second media transfer controller;
negotiating, by the second media transfer controller, transfer parameters with the target terminal;
negotiating, by the second media transfer controller, transfer parameters with the second media relay;
responding, by the first media transfer controller, to a transfer request of the source terminal; and
transferring the session to the target terminal according to the negotiated transfer parameters.

10. The method of claim 1, further comprising:
wherein the source terminal is attributable to a first media relay;
wherein the target terminal is attributable to a second media relay; and
wherein the first media relay and the second media relay are connected to one media transfer controller.

11. The method of claim 10, wherein the step of transferring the session to the target terminal according to the request by negotiating with the media relay further comprises:
negotiating, by the media transfer controller, transfer parameters with the target terminal;
negotiating, by the media transfer controller, transfer parameters with the first media relay;
negotiating transfer parameters with the second media relay;
notifying the first media relay;
responding to a transfer request of the source terminal; and
transferring the session to the target terminal according to the negotiated transfer parameters.

12. The method of claim 1, wherein the transferring the session to the target terminal according to the request by negotiating with the media relay further comprises:
confirming, by the media transfer controller, that the session can be transferred to the target terminal through a trust system.

13. A system for session migration, comprising:
a source terminal and a target terminal connected to a media transfer controller;
a media relay configured to connect the target terminal with the media transfer controller; and
a media transfer controller, configured to receive a request for transferring a session from the source terminal to the target terminal and transfer the session to the target terminal according to the request by negotiating with the media relay.

14. The system of claim 13, wherein:
the request is triggered by the source terminal;
the media transfer controller negotiates transfer parameters with the target terminal and the media relay;
the media transfer controller responds to the request of the source terminal; and
the media transfer controller transfers the session to the target terminal according to the negotiated transfer parameters.

15. The system of claim 13, wherein:
the request is triggered by the media transfer controller;
the media transfer controller transfers the session to the target terminal by negotiating with the media relay;
the media transfer controller negotiates transfer parameters with the target terminal;
the media transfer controller negotiates transfer parameters with the media relay; and
the media transfer controller transfers the session to the target terminal according to the negotiated transfer parameters.
